(19) United States
(12) Patent Application Publication
(10) Pub. No.: US 2024/0251806 A1
(43) Pub. Date: Aug. 1, 2024

(54) PROCESSING METHOD FOR AGING MEAT

(71) Applicant: DEEPLANT, INC., Goyang-si (KR)

(72) Inventor: Chul-beom KIM, Goyang-si (KR)

(21) Appl. No.: 18/630,014

(22) Filed: Apr. 9, 2024

Related U.S. Application Data
(63) Continuation of application No. PCT/KR2022/020216, filed on Dec. 13, 2022.

(30) Foreign Application Priority Data
Jan. 20, 2022 (KR) 10-2022-0008411

(51) Int. Cl. A23B 4/015; A23B 4/03

(52) U.S. Cl. CPC A23B 4/015; A23B 4/03

(57) ABSTRACT

The present disclosure relates to a processing method for aging meat. The processing method for aging meat is possible to maximize the tenderness, flavor, and texture of each meat by varying the ultrasonication time and aging period depending on the type of meat.

### CROSS-REFERENCE TO RELATED APPLICATIONS

This application is a continuation of PCT Application No. PCT/KR2022/020216, filed on Dec. 13, 2022, which claims priority to Korean Patent Applications No. 10-2022-0008411 filed on Jan. 20, 2022, both of which are hereby incorporated by reference in their entirety.

### TECHNICAL FIELD

The present disclosure relates to a processing method for aging meat.

### BACKGROUND

Aging refers to a phenomenon in which food is chemically and physically changed as time passes after being manufactured and nutrients in the food are appropriately broken down without being decayed by enzymes, microorganisms, salts, etc. In general, meat aging is performed at a temperature of 0° C. to 5° C. while inhibiting microbial growth. As for meat, when rigor mortis is maximized, the muscle tissues are digested by proteases, etc. and when the pH is restored, umami substances, such as amino acids and nucleic acid materials, are generated. Aging periods for optimal taste are different for different types of meat, and aging of bird meat, pork and beef is known to take 0.5 to 2 days, 3 to 6 days and 7 to 10 days on average, respectively. As the degree of aging of meat increases, the breakdown of myofibril microstructures by proteases becomes more severe, and, thus, the meat becomes tenderer.

### PRIOR ART DOCUMENT

### Patent Literature

Korean Patent Registered Publication No. 10-2329968

### DISCLOSURE OF THE INVENTION

### Problems to be Solved by the Invention

The present disclosure provides a processing method for aging meat.

However, problems to be solved by the present disclosure are not limited to the above-described problems, and although not described herein, other problems to be solved by the present disclosure can be clearly understood by those skilled in the art from the following descriptions.

### Means for Solving the Problems

A first aspect of the present disclosure provides a processing method for aging meat, including: (a) a step of performing ultrasonication on vacuum-packaged meat at a water temperature ranging from about −2° C. to about 10° C. and a water pressure ranging from about 10 atm to about 15 atm; and (b) a step of aging the ultrasonicated meat in a refrigerated state (b).

### Effects of the Invention

According to embodiments of the present disclosure, meat aged by a processing method for aging meat is improved in tenderness, flavor, and texture.

According to the processing method for aging meat in the embodiments of the present disclosure, meat is simultaneously applied with pressure and ultrasonic waves, and, thus, the resolution of rigor mortis of the meat and the onset of aging of the meat can be advanced. Therefore, it is possible to shorten the total meat aging period. Accordingly, it is possible to suppress the decay of meat caused by a long aging period that occurs in a conventional method of aging meat.

According to the processing method for aging meat in the embodiments of the present disclosure, it is possible to maximize the tenderness, flavor, and texture of each meat by varying the ultrasonication time and aging period depending on the type of meat.

According to the processing method for aging meat in the embodiments of the present disclosure, it is possible to control the tenderness, flavor, and texture of each meat by varying the ultrasonication time and aging period depending on the type of meat, and it can be classified into basic aging, deep aging, and deeper aging.

### BRIEF DESCRIPTION OF THE DRAWINGS

FIGS. 1A(i) to 1D(ii) provide transmission electron micrographs showing changes in muscle microstructures at different aging stages of beef (eye of round) according to an example of the present disclosure.

FIG. 2A to FIG. 2E are photographs of pork (Comparative Example) aged only through ultrasonication without the application of pressure according to an example of the present disclosure.

### BEST MODE FOR CARRYING OUT THE INVENTION

Hereinafter, embodiments and examples of the present disclosure will be described in detail with reference to the accompanying drawings so that the present disclosure may be readily implemented by those skilled in the art. However, it is to be noted that the present disclosure is not limited to the embodiments and examples but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A or B, or A and B”.

In the following description, exemplary embodiments of the present disclosure will be described in detail, but the present disclosure may not be limited thereto.

A first aspect of the present disclosure provides a processing method for aging meat, including: (a) a step of performing ultrasonication on vacuum-packaged meat at a water temperature ranging from about −2° C. to about 10° C. and a water pressure ranging from about 10 atm to about 15 atm; and (b) a step of aging the ultrasonicated meat in a refrigerated state (b).

In an embodiment of the present disclosure, in the step (a), the water temperature is most preferably about −2° C. to about 5° C.

In an embodiment of the present disclosure, in the step (a), the water pressure is most preferably about 10 atm.

In an embodiment of the present disclosure, in the step (a), the ultrasonication may be performed by using ultrasonic waves of about 2,000 W to about 3,000 W, but may not be limited thereto. In an embodiment of the present disclosure, in the step (a), the ultrasonication may be performed by using ultrasonic waves of most preferably about 2,400 W.

In an embodiment of the present disclosure, in the step (a), the ultrasonication may be performed for about 40 minutes to about 120 minutes, but may not be limited thereto. In an embodiment of the present disclosure, in the step (a), the ultrasonication may be performed for about 40 minutes to about 120 minutes, or about 60 minutes to about 120 minutes, but may not be limited thereto. In an embodiment of the present disclosure, the step (a), may induce meat to be tenderized in a short time and enhance an aging effect on meat. In an embodiment of the present disclosure, the processing method for aging meat may shorten the total meat aging period through the step (a). In an embodiment of the present disclosure, in the step (a), the ultrasonication time may be determined by at least one selected from the type, quality, and part of meat.

In an embodiment of the present disclosure, in the step (b), the refrigerated state may be kept at a temperature of from about −10° C. to about 5° C., but may not be limited thereto. In an embodiment of the present disclosure, in the step (b), the refrigerated state may be kept at a temperature of most preferably about −1° C.

In an embodiment of the present disclosure, in the step (b), the aging period may be determined by at least one selected from the type, quality, and part of meat.

In an embodiment of the present disclosure, in the step (b), the aging may be performed for about 1 day to about 7 days. For example, basic aging is possible by aging pork for about 1 day to about 7 days. For example, in the step (b), the aging may be performed for about 1 day to about 7 days, or about 1 day to about 6 days.

In an embodiment of the present disclosure, in the step (b), the aging may be performed for about 7 days to about 14 days. For example, deep aging is possible by aging pork for about 7 days to about 14 days. For example, basic aging is possible by aging beef for about 7 to about 14 days. For example, in the step (b), the aging may be performed for about 7 days to about 14 days, about 8 days to about 14 days, about 7 days to about 13 days, or about 8 days to about 13 days.

In an embodiment of the present disclosure, in the step (b), the aging may be performed for about 14 days to about 28 days. For example, deep aging is possible by aging beef for about 14 days to about 28 days. For example, in the step (b), the aging may be performed for about 14 days to about 28 days, or about 15 days to about 28 days.

In an embodiment of the present disclosure, the processing method may further include (c) a step of removing the vacuum packaging and performing additional aging in a dry ager after the step (b).

In an embodiment of the present disclosure, the dry ager may maintain a temperature of about 0° C. to about 10° C., but may not be limited thereto. In an embodiment of the present disclosure, the dry ager may maintain a temperature of most preferably about 3° C.

In an embodiment of the present disclosure, the dry ager may maintain a humidity of about 70% to about 90%. In an embodiment of the present disclosure, the dry ager may maintain a humidity of most preferably about 80%.

In an embodiment of the present disclosure, the step (c) may be performed for about 3 days to about 14 days, but may not be limited thereto. For example, deeper aging is possible by aging pork for about 3 days to about 14 days. For example, the step (c) may be performed for about 3 days to about 14 days, or about 3 days to about 13 days.

In an embodiment of the present disclosure, the step (c) may be performed for about 14 days to about 28 days, but may not be limited thereto. For example, deeper aging is possible by aging beef for about 14 days to about 28 days. For example, the step (c) may be performed for about 14 days to about 28 days, or about 15 days to about 28 days.

Hereinafter, example embodiments are described in more detail by using Examples, but the present disclosure may not limited to the Examples.

### MODE FOR CARRYING OUT THE INVENTION

### Example

### Example 1-1: Aging of Pork (Basic Aging)

1. Pork aged for 1 to 2 days after slaughter was prepared.

2. The pork was vacuum-packaged and then immersed in a hydraulic chamber with a water temperature of 5° C. or less, followed by treatment for 60 minutes under conditions of 100 m water pressure and 2400 W ultrasonic waves.

3. The pork treated as described in paragraph 2 was stored and aged in a refrigerator at −1° C. for 3 days.

### Example 1-2: Aging of Pork (Deep Aging)

1. Pork aged for 1 to 2 days after slaughter was prepared.

2. The pork was vacuum-packaged and then immersed in a hydraulic chamber with a water temperature of 5° C. or less, followed by treatment for 60 minutes under conditions of 100 m water pressure and 2400 W ultrasonic waves.

3. The pork treated as described in paragraph 2 was stored and aged in a refrigerator at −1° C. for 7 to 14 days.

### Example 1-3: Aging of Pork (Deeper Aging)

1. The vacuum package of the pork that had undergone the basic aging of Example 1-1 was removed.

2. The pork described in paragraph 1 was stored and aged in a specialized dry ager for 3 to 14 days (temperature of about 3° C., humidity of about 80%).

### Test Example 1: Evaluation of Meat Depending on Aging of Pork

Table 1 below shows the evaluation of the characteristics of meat depending on aging of pork.

TABLE 1

| | | not | Example 1-1 | Example 1-2 | Example 1-3 |
|---|---|---|---|---|---|
| | | sonicated | (basic aging) | (deep aging) | (deeper aging) |
| meat | brightness (L*) | 47.06 | 48.21 | 49.22 | 45.28 |
| color | redness (a*) | 5.45 | 5.62 | 5.81 | 6.34 |
| | yellowness (b*) | 1.02 | 0.81 | 1.03 | 1.23 |
| juice loss | | 2.03 | 1.89 | 1.78 | 1.53 |
| cooking loss | | 27.72 | 24.34 | 23.71 | 20.13 |
| pH | | 5.56 | 5.55 | 5.61 | 5.72 |
| thiobarbituric acid value | | 0.38 | 0.41 | 0.43 | 0.52 |
| (TBARS) | | | | | |
| warner bratzler shear force | | 3.66 | 3.42 | 3.03 | 2.48 |
| (WBSF) | | | | | |
| myofibrillar fragmentation | | 89.2 | 102.4 | 132.1 | 182.5 |
| index (MFI) | | | | | |
| electronic | sourness | −3.34 | −3.22 | −3.15 | −5.16 |
| tongue | richness | 3.45 | 3.52 | 3.73 | 4.04 |
| measurement | umami | 0.84 | 0.95 | 1.12 | 1.88 |

A meat color was determined by repeatedly measuring the surface meat color of the same sample three times with a Minolta Chroma meter (CR-300, Minolta Co. LTD. Japan), and standardized using a color standard plate: L*=93.5, a*=0.3132, and b*=0.3198.

A juice loss was calculated according to the formula below by collecting a sample with a 5-cm diameter core, measuring a weight (A) of the sample, hanging the sample in a plastic box with a lid, storing it in a refrigerator at 4° C. for 24 hours, and then measuring a weight (B) of the sample.

Juice loss (%)=[(A−B)/A)]×100

A cooking loss was calculated according to the formula below by uniformly cutting a sample with a 5-cm diameter core, measuring a weight (A) of the sample, wrapping the sample with a disposable plastic film, immersing the sample in a water bath with a temperature adjusted to 70° C., taking the sample out of the water bath after heating for exactly 30 minutes, cooling the sample, and then measuring a weight (B) of the sample.

Cooking loss (%)=[(A−B)/A]×100

After 3 g of the cut sample was homogenized with 27 mL of distilled water in a homogenizer (T25 basic, IKA Malaysisa) at 14,000 rpm for 1 minute, pH was measured with a pH-meter (MP230, Mettler Toledo, Swiss).

A thiobarbituric acid value (TBARS) was measured by putting 5 g of the sample in a 50-mL test tube, homogenizing the sample with 15 mL of distilled water and 50 μL of 10% butylated hydroxyanisole in a homogenizer (T25 basic, IKA Malaysisa) at 14,000 rpm for 30 seconds, transferring 1 mL of the homogenized sample to a 15-mL test tube, adding 2 mL of a thiobarbituric acid/trichloroacetic acid (TBA/TCA) solution into the test tube, and then shaking the test tube. The test tube containing the sample was heated at 90° C. for 15 minutes, followed by centrifugation at 3,000 rpm for 10 minutes. A 531 nm UV-Vis spectrometer (Agilent 8453, Santa Clara, Ca, USA) was used to measure 1 mL of the supernatant.

A shearing force(warner bratzler shear force; WBSF) was measured with a shearing machine (Instron Universal Testing Machine, Model 3343) by measuring the value of force applied when the sample whose cooking loss had been measured was completely cut. Herein, the conditions required for measurement by the machine were a load cell of 50 kg and a cross head speed of 100 mm/min.

A myofibrillar fragmentation index (MFI) was measured by putting 2 g of the sample in 40 mL of a buffer solution (0.1 M potassium chloride, 0.02 M potassium phosphate, 0.001 M magnesium chloride, 0.001 M sodium azide, and 0.001 M ethylenediaminetetraacetic acid disodium salt) refrigerated at 4° C. and homogenizing the sample at 10,000 rpm for 30 seconds. The homogenized sample was centrifuged for 15 minutes to separate the supernatant. After 40 mL of the buffer solution was added to the remaining lower liquid, the entire process was repeated. Then, 10 mL of the buffer solution was added to the remaining lower liquid, followed by homogenization at 10,000 rpm for 30 seconds. Finally, after homogenization, 10 mL of the buffer solution was added into a 50-mL tube and the remaining connective tissue was removed by sifting through an 18-eye sieve. The protein concentration of the filtered solution was determined by the Biuret method, and a myofibril suspension was diluted to a final protein concentration of 0.5±0.05 mg/mL with a potassium phosphate buffer solution. The diluted suspension was measured repeatedly three times with a 540 nm UV-Vis spectrometer, and the average value was multiplied by 150 to obtain the MFI.

An electronic tongue test was conducted by adding 400 mL of 85° C. distilled water to 100 g of the sample, extracting taste-related substances using a stirrer for 20 minutes, putting 40 mL of a solution containing taste substances filtered through a Whatman filter paper No. 1 into each of two 50-mL test tubes, and measuring the intensities of sourness, bitterness, astringency, umami, and saltiness of the filtered sample solution with an electronic tongue tester (Taste Sensing System SA402A, Insent, Japan).

Referring to Table 1, shearing forces obtained by mechanically measuring the toughness of meat were measured as 3.42, 3.03, and 2.48 in basic aging, deep aging, and deeper aging, respectively. In general, meat feels tender when the shearing force of the meat is 3.5 or less. Also, the values of Richness and umami measured with the electronic tongue increased in the order of basic aging, deep aging, and deeper aging. In summary, it was confirmed that the pork aged according to the examples of the present disclosure increased in tenderness and flavor as the aging period increased.

### Example 2-1: Aging of Beef (Basic Aging)

1. Beef aged for 1 to 2 days after slaughter was prepared.

2. The beef was vacuum-packaged and then immersed in a hydraulic chamber with a water temperature of 5° C. or less, followed by treatment for 60 minutes under conditions of 100 m water pressure and 2400 W ultrasonic waves.

3. The beef treated as described in paragraph 2 was stored and aged in a refrigerator at −1° C. for 7 days.

### Example 2-2: Aging of Beef (Deep Aging)

1. Beef aged for 1 to 2 days after slaughter was prepared.

2. The beef was vacuum-packaged and then immersed in a hydraulic chamber with a water temperature of 5° C. or less, followed by treatment for 60 minutes under conditions of 100 m water pressure and 2400 W ultrasonic waves.

3. The beef treated as described in paragraph 2 was stored and aged in a refrigerator at −1° C. for 14 to 21 days.

### Example 2-3: Aging of Beef (Deeper Aging)

1. The vacuum package of the beef that had undergone the basic aging of Example 2-1 was removed.

2. The beef described in paragraph 1 was stored and aged in a specialized dry ager for 14 to 21 days (temperature of about 3° C., humidity of about 80%).

### Test Example 2: Evaluation of Meat Depending on Aging of Beef (Eye of Round)

Table 2 below shows the evaluation of the characteristics of meat depending on aging of beef (eye of round).

TABLE 2

| | | not | Example 2-1 | Example 2-2 | Example 2-3 |
|---|---|---|---|---|---|
| | | sonicated | (basic aging) | (deep aging) | (deeper aging) |
| meat | brightness (L*) | 38.71 | 39.98 | 40.99 | 36.43 |
| color | redness (a*) | 20.32 | 20.53 | 20.84 | 22.43 |
| | yellowness (b*) | 7.31 | 7.95 | 7.22 | 8.01 |
| juice loss | | 1.43 | 1.30 | 1.21 | 1.08 |
| cooking loss | | 29.43 | 29.57 | 32.92 | 24.09 |
| pH | | 5.56 | 5.58 | 5.57 | 5.75 |
| TBARS | | 0.36 | 0.38 | 0.41 | 0.48 |
| WBSF | | 5.54 | 4.86 | 4.38 | 3.65 |
| MFI | | 76.4 | 98.5 | 142.4 | 173.8 |
| electronic | Sourness | −6.89 | −7.02 | −7.45 | −8.03 |
| tongue | Richness | 6.05 | 6.44 | 6.68 | 7.53 |
| measurement | Umami | 1.58 | 1.66 | 1.84 | 2.34 |

Herein, each of the above characteristics was evaluated as in Test Example 1.

Referring to Table 2, shearing forces were measured as 4.86, 4.38, and 3.65 in basic aging, deep aging, and deeper aging, respectively, which confirmed that tenderness increased as the aging period increased. The values of, sourness, richness and umami increased in the order of basic aging, deep aging, and deeper aging. In summary, it was confirmed that the beef aged according to the examples of the present disclosure increased in tenderness and flavor as the aging period increased.

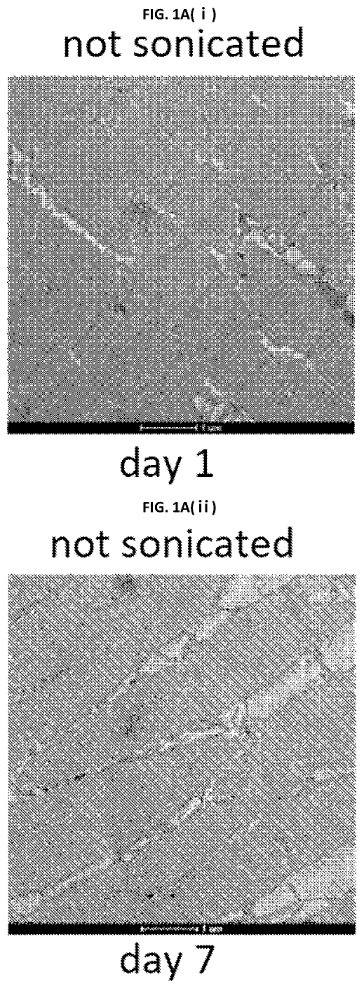

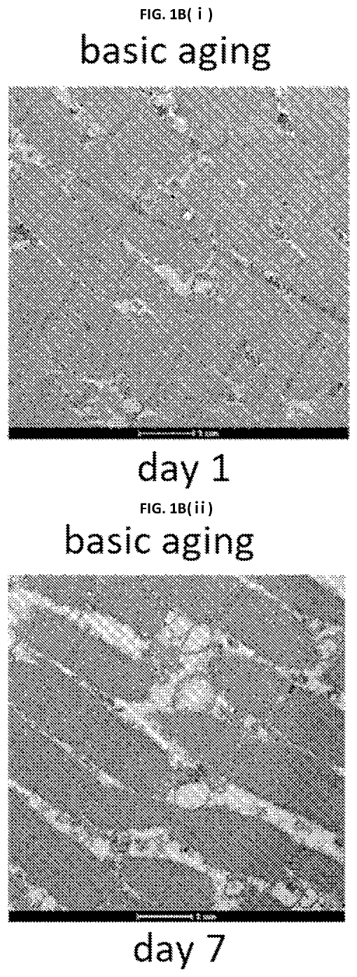

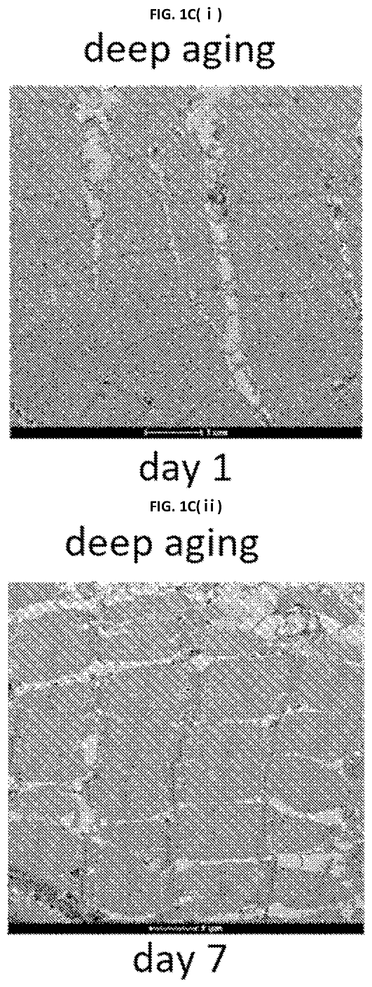

Also, FIGS. 1A(i) to 1D(ii) provide transmission electron micrographs showing changes in muscle microstructures at different aging stages of beef (eye of round). For TEM analysis, samples with a diameter of 1 mm to 2 mm were fixed using 2.5% glutaric aldehyde acid and 1% osmium tetroxide, dehydrated using 50% to 100% ethyl alcohol, and polymerized with low-viscosity epoxy resin. The samples each having a cross-section with a thickness of 30 nm were collected and stained with 3% uranyl acetate and lead citrate. The stained samples were photographed with a Talos L120C transmission electron microscope (120 kV, Talos L120C, FEI, Hillsboro, OR, USA).

It was confirmed that muscle microstructures of beef subjected to basic aging, deep aging, and deeper aging became tender compared to the case where ultrasonication was not performed. Also, when photographs of the beef taken on Day 1 and Day 7 of each of basic aging, deep aging, and deeper aging were compared, it was confirmed that the muscle microstructures became tender as the aging period increased.

### Comparative Example 1

1. Pork aged for 1 to 2 days after slaughter was prepared.

2. The pork was vacuum-packaged and then immersed in a chamber with a water temperature of 5° C. or less, followed by treatment for 60 minutes under conditions of 2400 W ultrasonic waves without the application of pressure.

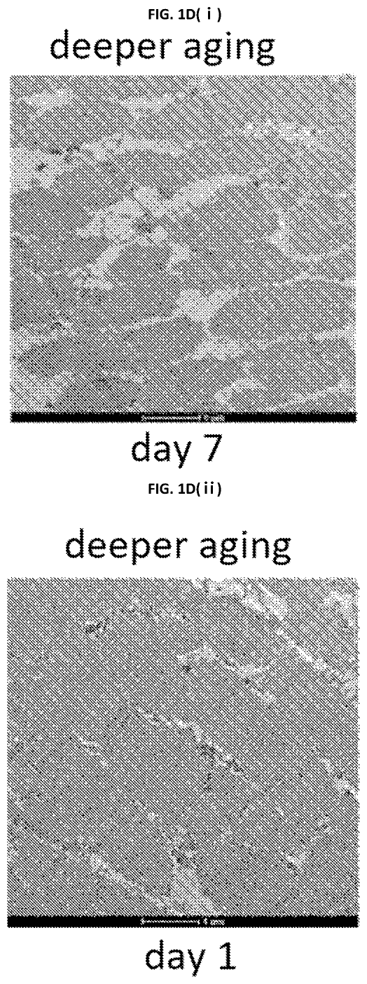

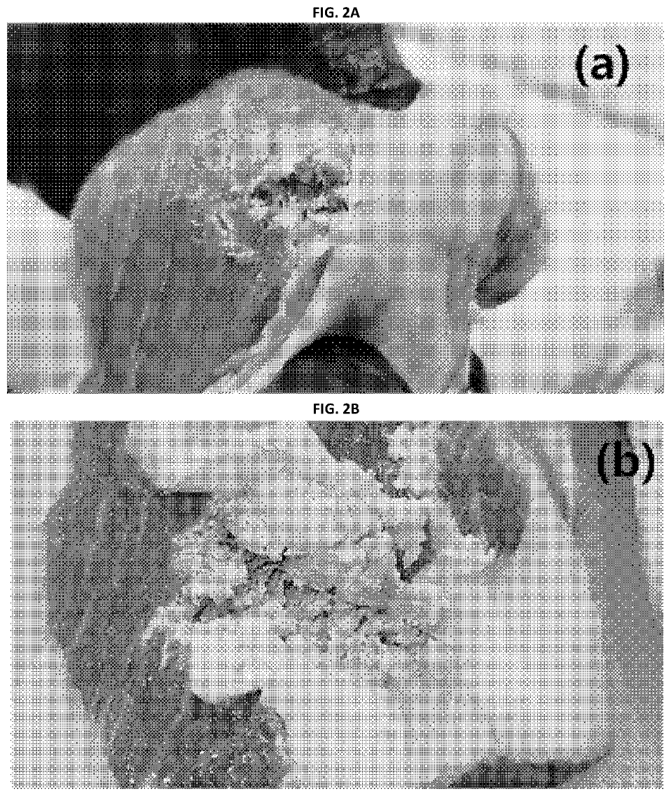

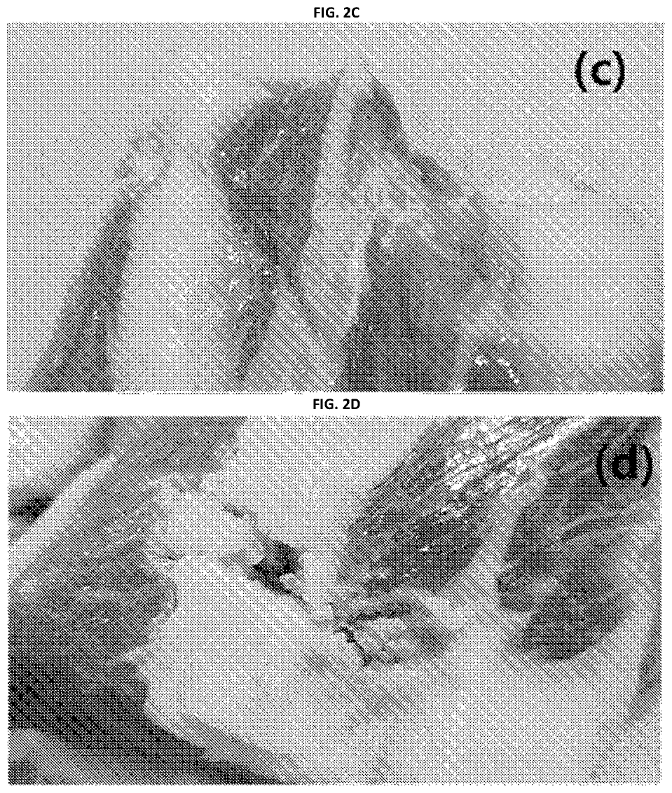

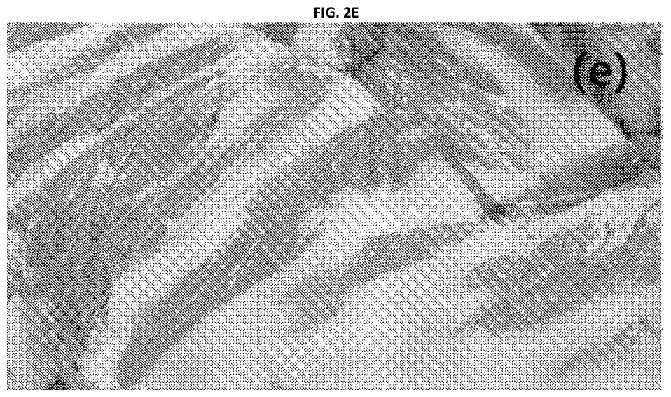

FIG. 2A to FIG. 2E are photographs of pork that had undergone ultrasonication only, and shows necrosis. Accordingly, it was confirmed that ultrasonication has the effect of aging meat without necrosis when it is performed under a certain water pressure.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

We claim:

1. A processing method for aging meat, comprising:
(a) a step of performing ultrasonication on vacuum-packaged meat at a water temperature ranging −2° C. to 10° C. and a water pressure ranging 10 atm to 15 atm; and
(b) a step of aging the ultrasonicated meat in a refrigerated state (b).

2. The processing method of claim 1,
Wherein in the step (a), the ultrasonication is performed by using ultrasonic waves of 2,000 W to 3,000 W.

3. The processing method of claim 1,
wherein in the step (a), the ultrasonication is performed for 40 minutes to 120 minutes.

4. The processing method of claim 1,
wherein in the step (b), the refrigerated state is kept at a temperature of −10° C. to 5° C.

5. The processing method of claim 1,
wherein in the step (b), the aging period is determined by at least one selected from the type, quality, and part of meat.

6. The processing method of claim 1,
Wherein in the step (b), the aging is performed for 1 day to 7 days.

7. The processing method of claim 1,
wherein in the step (b), the aging is performed for 7 days to 14 days.

8. The processing method of claim 1,
Wherein in the step (b), the aging is performed for 14 days to 28 days.

9. The processing method of claim 1, further comprising:
(c) a step of removing the vacuum packaging and performing additional aging in a dry ager after the step (b).

10. The processing method of claim 9,
wherein the dry ager maintains a temperature of 0° C. to 10° C.

11. The processing method of claim 9,
wherein the dry ager maintains a humidity of 70% to 90%.

12. The processing method of claim 9,
wherein the step(c) is performed for 3 days to 14 days.

13. The processing method of claim 9,
wherein the step (c) is performed for 14 days to 28 days.
